(19) United States
(12) Patent Application Publication
(10) Pub. No.: US 2006/0018205 A1
(43) Pub. Date: Jan. 26, 2006

(54) System and method for displaying media playing information

(75) Inventors: Ming-Xiong Liao, Shenzhen (CN); Gang Liu, Shenzhen (CN); De-Hua Dang, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/148,589

(22) Filed: Jun. 9, 2005

(30) Foreign Application Priority Data
Jul. 23, 2004 (TW) 93122064

(51) Int. Cl. G11B 11/00

(52) U.S. Cl. 369/18

(57) ABSTRACT

A computer system for displaying media playing information includes: media playing software installed in a host computer (1) for playing media files; a media playing controller (11) enchased on a front panel of the host computer for receiving user-input commands to control the media playing software; an LCD (Liquid Crystal Display) panel (12); a motherboard (2) including a CPU (Central Processing Unit) (21) and a south bridge chipset (22) for obtaining the media playing information from the media playing software; and a plug-in board (3) including: a PCI (Peripheral Component Interface) chipset (31) for receiving the media playing information from the motherboard; a media information obtaining module (32) for obtaining the media playing information from the PCI; and a media information displaying module (33) for controlling the LCD panel to display the media playing information. A related method is also disclosed.

### BACKGROUND OF THE INVENTION

1. Field of the Invention

The present invention relates generally to information displaying systems and methods, and more particularly to a system and method for displaying media playing information.

2. General Background

Media playing software (e.g. Windows Media Player) usually displays playing information on a monitor screen when playing CDs, VCDs or DVDs. However, this method enables users to observe the playing information only when the monitor screen is powered on. When the users are observing the playing information, they won't be able to run other applications on the same monitor screen. Furthermore, the traditional displaying information is generally limited to media file's names, lyrics, and few cartoons.

With the development of science and technology and improvement in the computing ability of personal computers, more entertainment functions are added into the computers in order to fulfill individualized requirements for media playing. Related art is disclosed in patents such as TW Patent No. 481,764 issued on Apr. 1st, 2004 and entitled “Playing CDs in Power Saving Mode”. This patent discloses a computer system which can calculate the time needed to play a CD. The computer system runs under a power saving mode for a period of the calculated time. Then, the computer system turns into a normal mode. However, the power saving mode can only be run in an operating system circumstances, and all the displaying information are shown on the monitor screen.

What is needed, therefore, is a system and method for displaying media playing information, which can display media playing information even when a monitor display is powered off in order to reduce power consumption and bring more entertainment to computer users.

### SUMMARY

A computer system for displaying media playing information is provided herein in accordance with one preferred embodiment of the present invetion. The system includes: media playing software installed in the computer for playing media files; a media playing controller enchased on a front panel of the computer for receiving user-input commands to control the media playing software; an LCD (Liquid Crystal Display) panel enchased on the front panel of the computer for displaying the media playing information; a motherboard including a CPU (Central Processing Unit) and a south bridge chipset for obtaining the media playing information from the media playing software; and a plug-in board including: a PCI (Peripheral Component Interface) chipset for receiving the media playing information from the motherboard and generating media controlling commands according to the user-input commands from the media playing controller; a media information obtaining module for obtaining the media playing information and receiving the media playing commands from the PCI chipset; and a media information displaying module for executing the media playing commands to control the LCD panel to display the media playing information.

A method for displaying media playing information in a computer system is also provided herein. The method comprises the steps of: displaying a startup cartoon when a Windows Operating System is being started; closing the startup cartoon when a user opens media playing software; obtaining media playing information on a media file being played and transmitting the media playing information to an LCD panel; displaying the media playing information on the LCD panel; checking whether a command to close the media playing software is received; and displaying a system time and a closedown cartoon if such a command is received.

Other advantages and novel features of the invention will become more apparent from the following detailed description when taken in conjunction with the accompanying drawings, in which:

### BRIEF DESCRIPTION OF THE DRAWINGS

FIG. 1 is an apparent diagram of a system for displaying media playing information according to a preferred embodiment of the present invention;

FIG. 2 is a block diagram of internal infrastructure of the host computer of FIG. 1;

FIG. 3 is a flowchart of a preferred method for displaying media playing information by utilizing the system of FIG. 1; and

FIG. 4 is a flowchart of a preferred method for obtaining media playing information on a media file being displayed.

### DETAIL DESCRIPTION OF THE PREFERRED EMBODIMENT

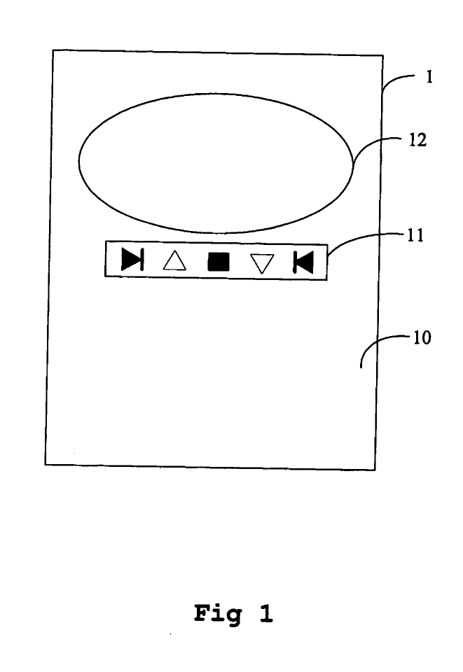

FIG. 1 is an apparent schematic diagram of a system for displaying media playing information (hereinafter, “the system”) according to a preferred embodiment of the present invention. A media playing controller 11 and an LCD (Liquid Crystal Display) panel 12 are enchased on a front panel 10 of a host computer 1. The media playing controller 11 receives user-input commands to control media playing software installed in an Operating System of the host computer 1. The commands may include start/pause of a media file, selection of a media file to be played, control of the volume, and so on. The media playing software can be a Windows Media Player, a RealPlayer, an MP3 Player or any other media player known in the art. In this preferred embodiment, the media playing software is a Windows Media Player running in a Windows OS. The LCD panel 12 is used for displaying media playing information, which may, for example, include a playing status, a name of the media file being played, and the volume.

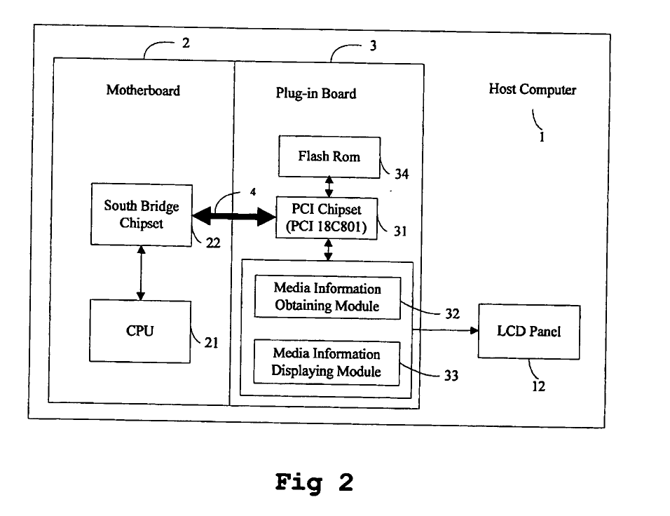

FIG. 2 is a block diagram of internal infrastructure of the host computer 1. The host computer 1 includes: (1) a motherboard 2 including at least a CPU (Central Processing Unit) 21 and a south bridge chipset 22 (e.g. Sis 963 SB) for obtaining media playing information from the Windows media player; (2) a plug-in board 3 which has at least a PCI (Peripheral Component Interconnect) chipset 31 (e.g. 18C801 chipset), a media information obtaining module 32, a media information displaying module 33, and a Flash ROM 34; (3) a system bus (SMBus) for connecting the south bridge chipset 22 with the PCI chipset 31. The PCI chipset 31 is used to receive the media playing information from the south bridge chipset 22, and to generate media playing commands to control the LCD panel 12. The media information obtaining module 32 obtains the media playing information and the media playing commands from the PCI chipset 31. The media information displaying module 33 executes the media playing commands to control the LCD panel 12. The Flash ROM 34 is a device to store program codes of all relevant applications used to perform the system.

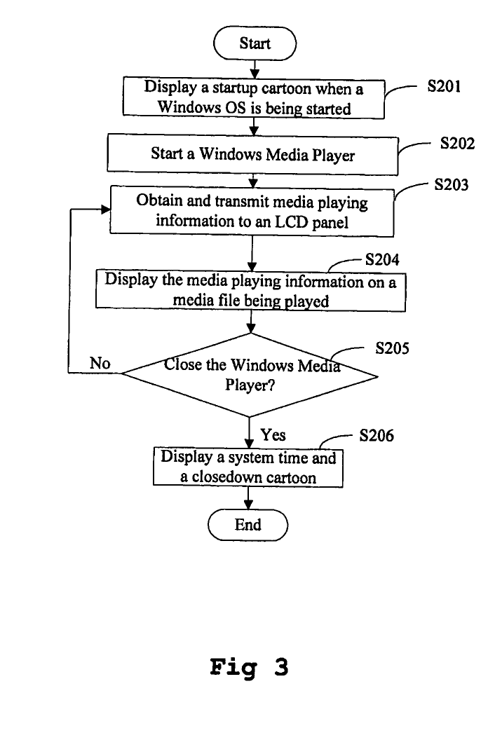

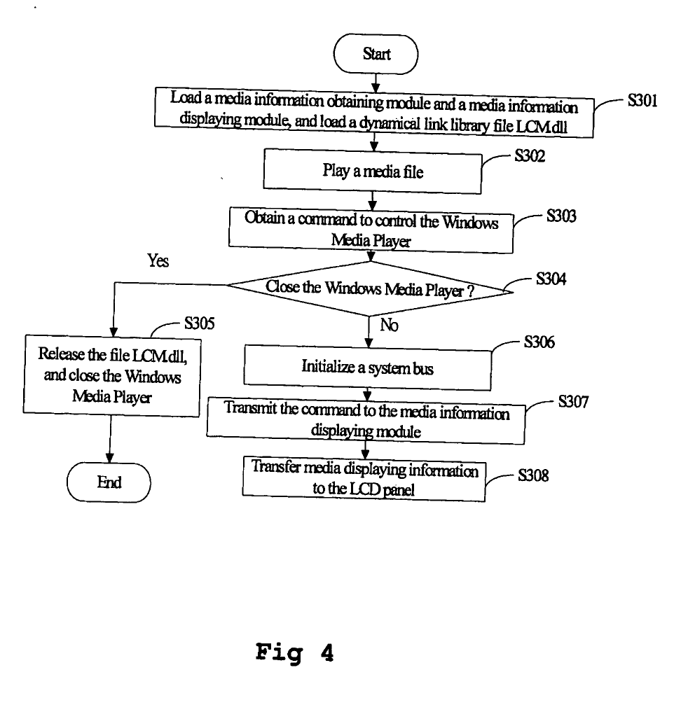

FIG. 3 is a flowchart of a preferred method for displaying media playing information on a media file being displayed. In step S201, the LCD panel 12 displays a startup presentation like a startup cartoon when a Windows OS is being started. In step S202, the startup cartoon is closed when a user opens a Windows Media Player. In step S203, media information obtaining module 32 obtains media playing information from the Windows Media Player, and transmit the media playing information to the LCD panel 12. Detailed description of this step will be shown below in relation to FIG. 4. In step S204, the media information displaying module 33 controls the LCD panel 12 to display basic information on the media file being played. The basic information may include a name of the media file, and a total time to play the media file. In step S205, the media information obtaining module 32 determines whether a command to close the Windows Media Player is received. If such a command is received, in step S206, the LCD panel 12 displays a system time and a closedown presentation like a closedown cartoon, whereupon the procedure is ended. Otherwise, the procedure goes to step S203 described above.

FIG. 4 is a flowchart of details of step S203, namely, obtaining media playing information on a media file being displayed. In step S301, the system loads the media information obtaining module 32 and the media information displaying module 33, and loads a dynamical link library file LCM.d11. In step S302, a user starts the Windows Media Player to play the media file via the media playing controller 11. In Step S303, the media information obtaining module 32 obtains media playing information on the media file from the Windows Media Player and a media playing command to control the Windows Media Player from the media playing controller 11. In step S304, the media information obtaining module 32 determines whether the media playing command is a command to close the Windows Media Player. If the media playing command is a command to close the Windows Media Player, in step S305, the media information obtaining module 32 releases the file LCM.d11, and closes the Windows Media Player, whereupon the procedure is ended. Otherwise, if the media playing command is not a command to close the Windows Media Player, in step S306, the file LCM.d11 initializes the system bus 4 as available. In step S307, the PCI chipset 31 transmits the media playing command to the media information displaying module 33. In step S308, the media information displaying module 33 transmits the media playing information to the LCD panel 12.

Although the present invention has been specifically described on the basic of a preferred embodiment and a preferred method, the invention is not to be construed as being limited thereto. Various changes and modifications may be made to the embodiment and the method without departing from the scope and spirit of the invention.

We claim:

1. A computer system for displaying media playing information, comprising:
media playing software installed in the computer for playing media files;
a media playing controller enchased on a front panel of the computer for receiving user-input commands to control the media playing software;
an LCD (Liquid Crystal Display) panel enchased on the front panel of the computer for displaying the media playing information;
a motherboard comprising a CPU (Central Processing Unit) and a south bridge chipset for obtaining the media playing information from the media playing software; and
a plug-in board comprising:
a PCI (Peripheral Component Interface) chipset for receiving the media playing information from the motherboard and generating media controlling commands according to the user-input commands from the media playing controller;
a media information obtaining module for obtaining the media playing information and receiving the media playing commands from the PCI chipset; and
a media information displaying module for executing the media playing commands to control the LCD panel to display the media playing information.

2. The system according to claim 1, wherein the plug-in board further comprises a Flash ROM for storing program codes of all applications used in the system.

3. The system according to claim 1, wherein the PCI chipset is a 18C801 chipset.

4. A method for displaying media playing information in a computer system, comprising the steps of:
displaying a startup cartoon when a Windows Operating System is being started;
closing the startup cartoon when a user opens media playing software;
obtaining media playing information on a media file being played and transmitting the media playing information to an LCD panel;
displaying the media playing information on the LCD panel;
checking whether a command to close the media playing software is received; and
displaying a system time and a closedown cartoon if such a command is received.

5. The method according to claim 4, wherein the media playing information comprises a status of playing the media file, a name of the media file, and the volume.

6. The method according to claim 4, wherein the step of obtaining media playing information on a media file being played comprises the steps of:
loading a media information obtaining module and a media information displaying module in the computer system;
opening the media playing software via a media playing controller to play the media file;
obtaining the media playing information from the media playing software and a media playing command from the media playing controller;
determining whether the media playing command is a command to close the media playing software;
initializing a system bus if the medial playing command is not a command to close the media playing software;
transmitting the media playing command to the media information displaying module; and
transmitting the media displaying information to the LCD panel.

7. The method according to claim 6, wherein the step of determining whether the media playing command is a command to close the media playing software comprises the step of closing the media playing software if the media playing command is a command to close the media playing software.

8. A method for displaying media playing information related to a media file to be played in a computer system, comprising the steps of:
programming said computer system to be operable for playing said media file;
retrieving said media playing information via said programmed computer system; and
displaying said media playing information on a display of said computer system during said playing of said media file.

9. The method according to claim 8, further comprising the steps of displaying a startup presentation indicating starting of programming before said programming step, and displaying a closedown presentation in case that operability of said playing of said media file is required to be terminated after said programming step.

10. The method according to claim 8, wherein a media playing software is used to program said computer system for operability of said playing of said media file in said programming step, and said media playing software is one of the group consisting of Windows Media player, RealPlayer and MP3 player.
